(19) United States
(12) Patent Application Publication
(10) Pub. No.: US 2006/0195609 A1
(43) Pub. Date: Aug. 31, 2006

(54) Internal natural domain service system with local name servers for flexible top-level domains

(76) Inventor: Young Seok Han, KYOUNGGI-DO (KR)

Correspondence Address: BACON & THOMAS, PLLC, 625 SLATERS LANE, FOURTH FLOOR, ALEXANDRIA, VA, 22314, US

(21) Appl. No.: 10/523,405

(22) PCT Filed: Aug. 1, 2003
(86) PCT No.: PCT/KR03/01554

§ 371 Date: Feb. 3, 2005

(30) Foreign Application Priority Data
Aug. 5, 2002 (KR) 10-2002-0046046

(51) Int. Cl. G06F 15/16; G06F 7/00

(52) U.S. Cl. 709/245; 700/217

(57) ABSTRACT

Extended internal domain name service of URI taking distributed service scheme, wherein site names or proper nouns that are not formal top-level domains are used as top-level domains. A central name server, a local name server and a user computer, each of which is loaded with a program for domain service. A service preparation step, the local name server registers a name and address of a site into the central name server and is given a top-level domain from the central name server. A name registration step, the local name server gives names to resources inside a site or site user registers names of information into the local name server. A domain inquiry step, the user computer inquires internal domains of particular local name server without confusion to existing domain service when user inputs internal domains according to a domain scheme.

### TECHNICAL FIELD

The present invention relates to a new name service improving conventional domain name services, and more particularly, to an extended internal domain name service of a new URI form taking a distributed service scheme, wherein site names or proper nouns that are not top-level domains can be used as top-level domains.

### BACKGROUND ART

With the development and popularization of the Internet, new formal top-level domains have been employed in addition to conventional formal top-level domains such as “com”, “gov”, and the like since 2001. These employed formal top-level domains include “name”, “shop”, “biz” and the like. But, these employed formal top-level domains are not only quite small in number but also quite low in their use compared to the top-level domain “com”. On the other hand, as an alternative domain service form there have been published services named “Hangul (Korean alphabet) domain” in Korea, which are capable of expressing site addresses (names) by Hangul.

However, the several newly introduced top-level domains and the introduced Hangul domain name or one's native tongue domain name have been not widely spread in actuality. The reason for this is that a main use of the several new top-level domains in addition to the existing domains or the Hangul domain service is to search sites, similar to a role of the conventional top-level domain “com”.

The domain names in the prior art have a difficulty in granting names to resources in the unit of site. In the prior art, therefore, in order to search a number of contents in each site, a concerned site is found and then search methods in the site should be used. In addition, if a domain name of the concerned site is unknown, a separate Internet search site should be used. In Korea, in order to solve this problem, a name scheme called “jumbyul service” or “jumbyul name” expanding an existing name concept has been developed. This service is distinguished from the prior name services in that the former is a service of a concept that resources in a database, which can be referred to as contents or resources in a site, are named and directly accessible in a one to one way. In the present invention, this name scheme of the URI (Uniform Resource Identifier) concept is referred to as “Internal Natural Domain”.

Recognizing limitations of existing IP address and domain system and expecting an era when unique IP addresses are given to all resources, studies of enlargement of an IP address consisting of 4 bytes at present have been internationally made. The domain made for access to all resources, i.e., the URI, is being studied toward expansion of systems and addition of protocols based on an existing DNS. (See RFC2396 and RFC1738. The total number of defined protocols is 47 on July 2002. Examples of the defined protocols include “http”, “ftp”, “gopher”, “mailto”, “telnet”, etc.) However, it is difficult to implement these protocols as they become more complicated in grammar, and there is a problem that a domain system is established on the basis of alphabet characters.

The “byul name” can be referred to as a protocol which is a new kind of URI developed in Korea. The “byul name” is different from existing name schemes in that existing site names themselves rather than the prior top-level domains such as “com” and “kr” become a top-level domain. By doing so, internal domains (i.e., such as “internal-domain.site name”) are some more emphasized. However, since this “byul name” is a centralized name service scheme, it has a problem that information can be easily exposed and the autonomy of service is limited. This gives a motive to the present invention. In other words, an object of the present invention is to design a new URI protocol taking a distributed service scheme with a naming scheme such as the existing “byul name”.

On the other hands, existing name servers are being operated with name service function and search function separated from each other. That is, the name servers perform one to one mapping but perform a search in a service such as a MSN search service if the one to one mapping is failed. Such a dual system fails to provide a natural and precise search for a user.

### DISCLOSURE OF THE INVENTION

Accordingly, the present invention has been made keeping in mind the above problems occurring in the prior art, and an object of the present invention is to provide a name service of a new URI form taking a distributed service scheme, where site names or proper nouns can be used as a top-level domain.

In an aspect of service method, an object of the present invention is to provide a name search access method (security) which providing the following functions: 1) to provide a central name service enabling occasional registration and deletion of a top-level domain and a local name service suitable to management of an internal domain, 2) to request a search through direct access of a user computer to a local name server of a concerned site with no affection on existing various domain services except for an extended internal domain, 3) to equip a similar domain search function as a basic function of a name server, and 4) to allow only certain users to search certain names in the course of the search.

The reason of introduction of a security concept is that a service environment to which the present invention is applied is provided to not only a system administrator but also common users of sites. In other words, the present invention should deal with all cases that domains should be given to not only completely public resources but also resources, which are desired to be protected by individuals in their own regions.

The present invention has a difference in terms of service contents, service motive, and service applications from the existing one's native tongue domain system or the existing Hangul domain system for example. The existing one's native domain system or the existing Hangul domain system are operated regardless of the top-level domain, as shown in FIG. 7, but the present invention can provide a variety of services, which are independent of one another, based on the top-level domain. This existing Hangul domain service does not presume that separate name servers for internal domains are operated for each site, but presumes only any Hangul domain servers and lacks a concept of process of the Hangul domain by use of a polarity of (one's native tongue) name servers. On the other hand, the present invention does not have a concept of one's native tongue but rather comprehends all characters. Accordingly, domains in the present invention cannot be distinguished by conventional English letter domains and character codes. According to the present invention, since the top-level domains can be created infinitely and the local name servers can exist in proportion to the number of the top-level domains, a key point of design is harmony with the conventional domain name services. In addition, another objective of the present invention is to provide a domain system design including a search service and a security function, which were provided separately in the prior art.

The present invention provides a different form of name in a different scheme of domain name service from the conventional domain name service. That is, the present invention is different from the conventional domain name service in terms of a form of name, a service scheme, its use, and a concept of use. Particularly, the present invention allows direct access to materials and information rather than sites to be easily realized, as is targeted by URI schemes. In the case where domain applications are to be spread from names in the unit of site to names for resources inside a site (internal domain) and all characters including Hangul other than English letter is to be supported, the existing domain system has a limitation in the spread into the internal domain and the support of all characters. Particularly, the present invention is for domain format with a form of site name as the top-level domain and is directed to a design of internal domain server implement a name service with a scheme different from a scheme of the existing domain service system. The internal domain of the present invention is not limited by Hangul or English letter and can be expressed by any characters. In addition, in the present invention, a security function, which is not found in the existing domain server, is added.

The present invention includes a central name server, a local name server and a user computer, each of which is loaded with a program for domain service. In a service preparation step, the local name server registers a name and address of a site into the central name server and is given a top-level domain from the central name server. In a name registration step, the local name server gives names to resources inside a site or a site user registers names of his/her own information into the local name server. In a domain inquiry step, the user computer inquires internal domains of a particular local name server without giving any confusion to the existing domain service when the user inputs the internal domains according to a domain scheme. Finally, in a service execution step, the local name server provides a related domain service for a requested name according to a requested scheme.

The present invention uses site names, proper nouns and the like, which are not the top-level domains (i.e., “com”, “net”, “kr”, “jp”, etc.) in the prior art, as top-level domains. In addition, the extended internal domain service according to the present invention is the local domain service, which is provided by a separate server, not a conventional DNS server and can be registered, deleted and managed by all users. In addition, the present invention provides a search function closely connected with the domain service and a security function limiting a search and an access.

Naming Scheme

In light of a conventional domain representation taking a format such as “internal-domain.secondary domain.top-level domain” (e.g., www.uspto.gov), the present invention can free uses site names, proper nouns and common nouns for “top-level domain”, allows free registration and deletion for this top-level domain, and has no limitation on use in the top-level domain. The descriptive term “extended” is used in the point that a concept of the top-level domain is extended and the term “internal domain” is defined in the point that an access to internal resources is targeted. Particularly, the “extended internal domain” is a scheme completely different from conventional commonly used domains because of its flexible top-domain.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a drawing showing a relationship between components required for an extended internal domain service according to the present invention.

FIG. 2 is a flow chart for explaining an operation procedure of the user computer for the extended internal domain service according to the present invention.

FIG. 3 is a flow chart for explaining an operation procedure of the central name server for the extended internal domain service according to the present invention.

FIG. 4 is a flow chart for explaining an operation procedure of the local name server for the extended internal domain service according to the present invention.

FIG. 5 is a flow chart for explaining an operation procedure of an access security service of the local name server according to an embodiment of the present invention.

FIG. 6 is a flow chart for explaining an operation procedure of security in a similar domain search security service of the local name server according to other embodiment of the present invention.

FIG. 7 is a flow chart for explaining a operation procedure of Hangul domain service according to the conventional domain service.

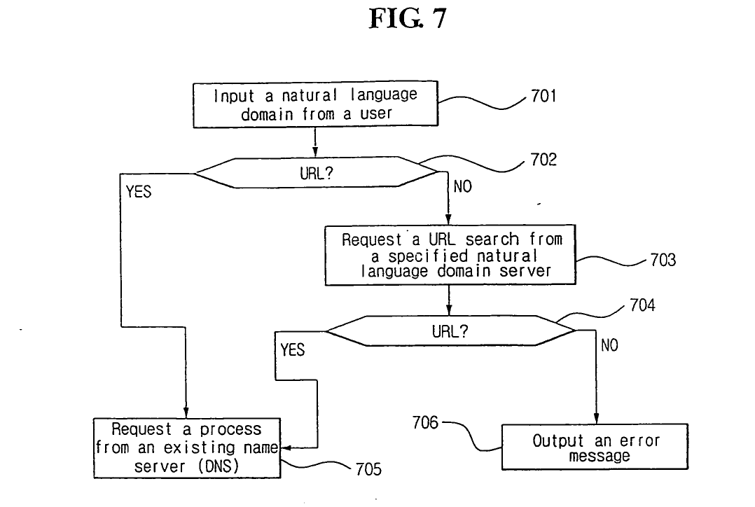

### BEST MODE FOR CARRYING OUT THE INVENTION

Hereinafter, the present invention will be in more detail described with reference to the drawings.

Basic Service Model

The present invention provides a name structure in which top-level domains can be freely defined, as mentioned above. In addition, the present invention provides a central name server, a local name server and a client program, each of which has no effect on the existing name service while operating in a scheme different from the existing DNS. The present invention provides a service in which security and search functions are organically coupled to each other. This results in a new form of URI protocol.

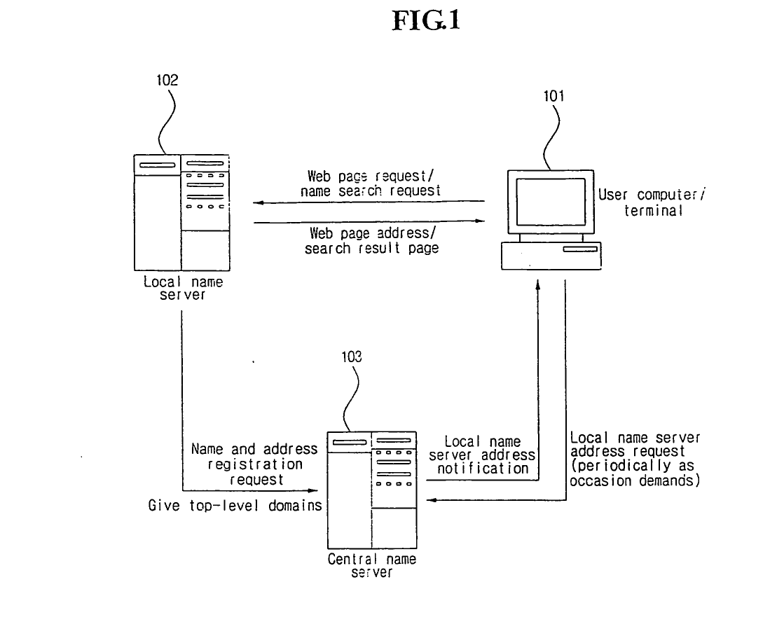

FIG. 1 shows a relationship between components required for an extended internal domain service according to the present invention.

When a user wishes to access other information on a network through a name, an URL (or an IP address) for the name should be found. The URL for the information is provided by the local name server 102, which is distributed in various places. Accordingly, the user computer 101 first inquires an address of the local name server of the central name server 103 providing management and search services for the address of the local name server in order to know the address of the local name server storing the URL for resources (information) desired by the user. In this course, each local name server 102 is distinguished one another by a top-level domain and operates separated from the conventional top-level domains (formal top-level domains).

The local name server 102 equips a local name server program for an internal domain service of a web site. The user computer 101 includes client software for the present invention. The client software operates in connection with a web browser or operates in connection with the local and central name servers by using a separate interface. The central name server 103 controls client software of the local name server and the user computer.

Each local name server 102 is given one or more unique top-level domains and the top-level domains are registered into the central name server 103 in connection with the local name server 102. In addition, contents (information pages, member pages, etc.) in a local site are also given a name, which is stored in the local name server 102 corresponding to the top-level domain with the name.

The user inputs contents of a particular site desired to be found by him/her in an address input window (or private software) of a web browser with a name such as “contents_name.site_name” along with an access scheme. The access scheme, which is similar to the scheme of the URL, represents a scheme for accessing the resources. This access scheme will be in detail described later.

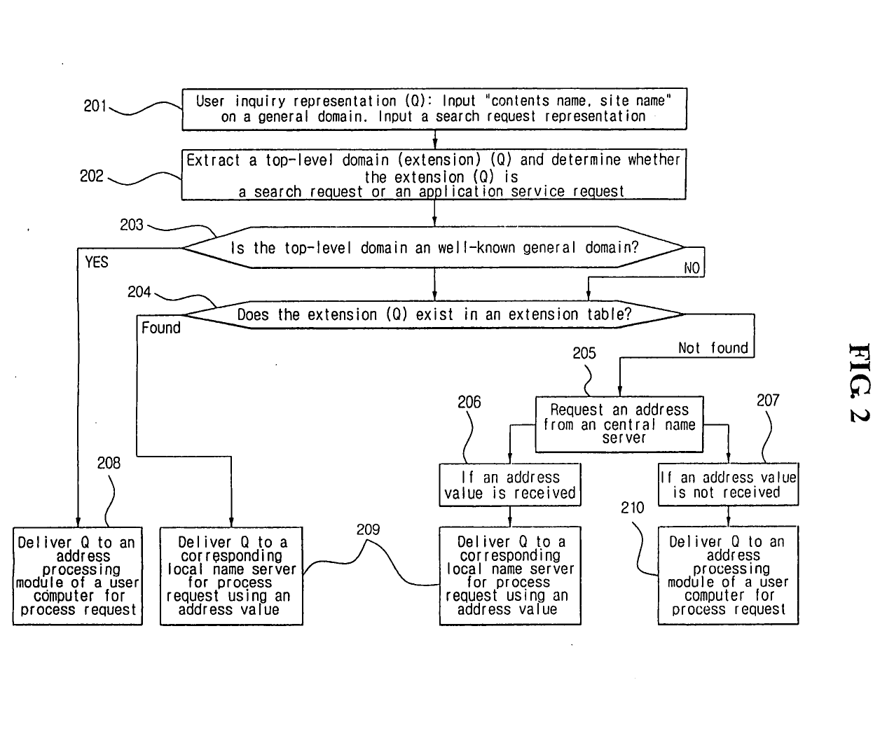

FIG. 2 shows a flow chart for explaining an operation procedure of the user computer for the extended internal domain service according to the present invention. The operation of the user computer 101 will be in derail described with reference to FIG. 2.

In Step 201, the user computer 101 receives a user inquiry representation Q from a user. The user inquiry representation can has a form of “content_name.site_name” or a normal domain name. Or it can be a search request representation according to the present invention.

In Step 202, the user computer 101 extracts a top-level domain (extension) ID from the name representation Q inputted by the user. In addition, it is determined whether the request of the user is a search request or an application service request. In Step 203, it is determined whether the extracted top-level domain is a formal top-level domain (i.e., “com”, “net”, “kr”, “jp”, “shop”, “biz”, “to”, etc.). If it is determined that the extracted top-level domain is a formal top-level domain, in Step 208, the user computer 101 passes the user inquiry representation Q to a browser (or a address processing system in connection with the existing DNS) for direct process.

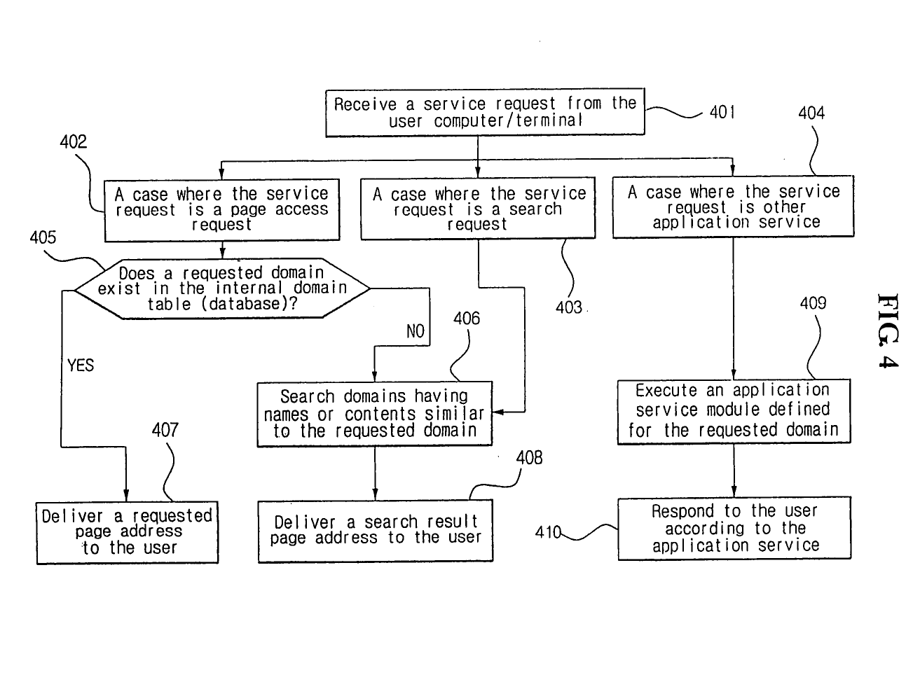

If it is determined in Step 203 that the extracted top-level domain is not a formal top-level domain, it is determined in Step 204 whether the extension D exists in a local extension table stored in the user computer 101. If it is determined that the extension D exists in the local extension table, in Step 209, an address of a local name server corresponding to the extension D is attained from the extension table and the user inquiry representation Q is delivered to the local name server to be requested to process the user inquiry representation Q. When the local name server 209 is requested for a page, a process is performed based on the requested service, which will be in detail described with reference to FIG. 4.

If it is determined in Step 204 that the extension D does not exist in the extension table, in Step 205, the user computer 101 delivers the extension D to the central name server 205 and requests an address of the local name server corresponding to the extension D.

Responding to the request of the user computer 101, the central name server 103 delivers the address or “no value” of the local name server corresponding to the extension D to the user computer 101.

When a value received from the central name server 103 is an address value of the local name server in Step 206, the user computer 101 delivers internal domain representation and information scheme (service classification) to the local name server with a concerned address in Step 209. If the value received by the user computer 101 is “no value” in Step 207, the user computer 101 passes the inquiry representation (name and scheme indication information) Q to a web browser, an address processing module such as a DNS access program for process.

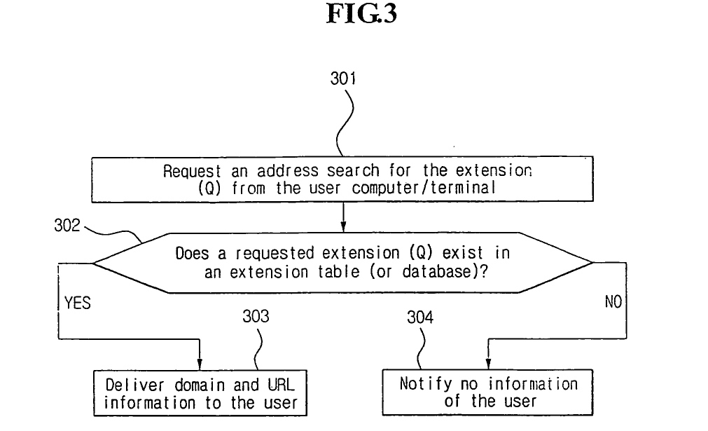

FIG. 3 shows a flow chart for explaining an operation procedure of the central name server for the extended internal domain service according to the present invention. The operation of the central name server 103 will be in detail described with reference to FIG. 3.

In Step 301, the central name server 103 receives a request for an address of the local name server associated with the extension D from the user computer 101. In Step 302, the central name server 103 determines whether the extension D is a top-level domain registered in the central name server. In other words, the central name server 103 determines whether the extension D is included in the extension table (or database) of the central name server 103.

If it is determined in Step 302 that the requested extension D is registered in the central name server 103, the central name server 103 delivers the address of the local name server corresponding to the extension D to the user computer. If it is determined in Step 302 that the requested extension D is a top-level domain not managed by the central name server 103, “no value” is notified to the user computer 101.

FIG. 4 shows a flow chart for explaining an operation procedure of the local name server for the extended internal domain service according to the present invention. The operation of the local name server 102 will be in detail described with reference to FIG. 4.

In step 401, when the local name server 102 receives a request for service from the user computer 101 or the central name server 103, Steps 402 to 404 are performed according to a characteristic (scheme or protocol) of the requested service.

Step 402 processes a case where the inquiry representation (name and scheme indication information) Q received by the local name server 102 is a page access request. In this case, the local name server 102 determines whether a requested domain is a domain managed by the local name server (i.e., exists in its internal domain table) in Step 405. If it is determined in Step 405 that the requested domain is stored in the internal domain table, a URL corresponding to the requested internal domain is delivered to the user computer in Step 407. If it is determined in Step 405 that the requested domain is not stored in the internal domain table, domains having names or contents similar to the requested domain are searched in Step 406 and then searched pages are delivered to the user computer in Step 408.

Step 403 processes a case where a search is requested from the beginning in the local name server 102. In this case, Steps 406 and 408 are directly performed and then similar domain search results are delivered to the user computer 101.

Step 404 processes a case where the request from the user is other application services. In other words, when services of other schemes are requested, an application service module defined for the requested domain is executed and then a process result is delivered to the user according to the application service.

The name process procedure of the name server according to the present invention can process all top-level domains including the existing formal top-level domains without causing confusion to the existing name systems (layer scheme, alphabet-based system, keyword scheme, etc). In addition, the present invention can preferentially support selection of the central name server managing top-level domains. In other words, if the central name server attempts to use “com” as a new top-level domain although it has no reason to do so, the formal top-level domain as the existing “com” may be useless.

In the basic service method as described above, an access, a search and other services for a given domain can be generally regarded as an “access” service and can also referred to as a service scheme or a protocol. That is, the present invention can provide various types of access services as “http://” relates to a service showing web pages and “ftp://” relates to a service delivering files in the case of the existing URI. The local name server performs all services including web page showing (access), similar domain searching (search), file delivering (other application), telephone calling (other application) and the like.

Specific Embodiments

Method for setting options of search security and access security in a procedure for registering names

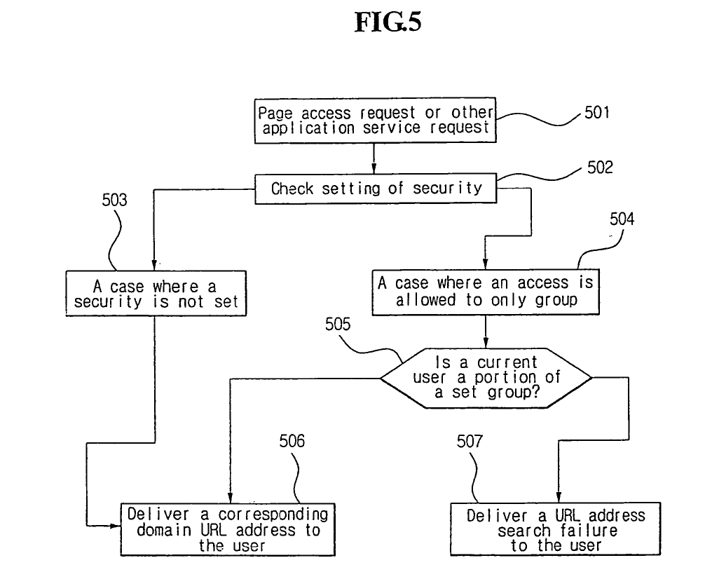

FIG. 5 shows a flow chart for explaining an operation procedure of an access security service of the local name server when the local name server receives a page access request (URL request) or other application service requests, according to the present invention.

In the present invention, the central name server 103 manages addresses of the local name server 102, the local name server 102 manages internal domains inside a particular site, and the user computer 101 performs an access to the central name server and the local name server.

An internal domain registrant to register a name in the local name server 102 using an internal domain representation, an address of a concerned page and the like sets a security such that the name cannot be searched or search/access/application services are allowed to only particular users.

If a request received by the local name server 102 is a page access request for a particular URL or a request for other application services in Step 501, steps after Step 502 are performed. In Step 502, the local name server 102 checks preset access security information. As a result of check, if no security is set and hence unconditional access is allowed in Step 503, a corresponding URL address is delivered to the user (a case where a requested service is a page access request) or a relevant service is called according to a requested scheme (a case where a requested service is other application service request) in Step 506.

As a result of check in Step 502, if an access is allowed to only a particular group, steps after Step 504 are performed. In Step 505, it is determined whether a current user is a member of the group set in the security setting. That is, an authentication for the user is performed. If the authentication for the user succeeds, a corresponding URL address is delivered to the user (a case where a requested service is a page access request) or a relevant service is called according to a requested scheme (a case where a requested service is other application service request) in Step 506. If the authentication for the user fails, the service failure is notified to the user in Step 507.

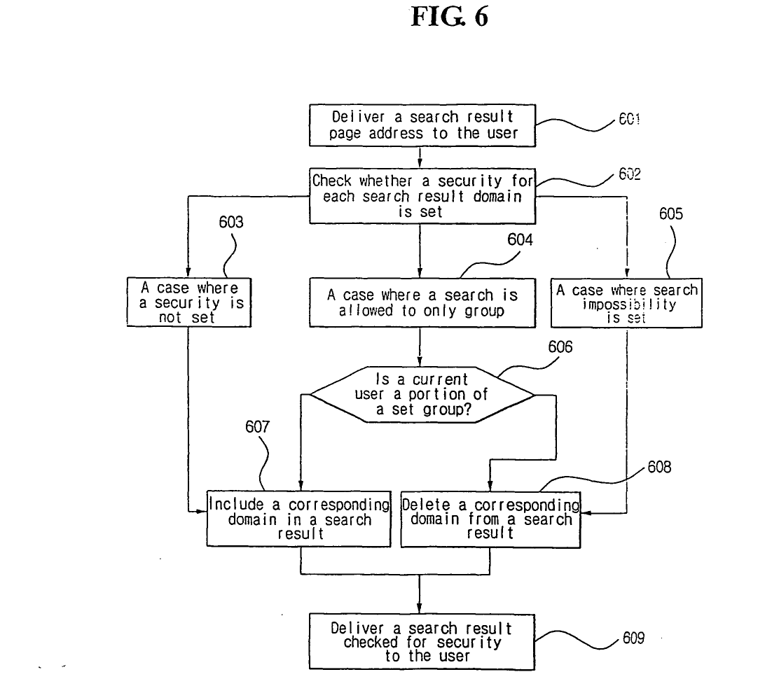

FIG. 6 shows a flow chart for explaining an operation procedure of security in a similar domain search security service of the local name server according to the present invention.

If the similar domain search is requested in Step 40S of FIG. 4, steps after Step 601 of FIG. 6 are performed. A search for domains having names or contents similar to the requested domain has already been preformed in Step 406 before Step 601. In Step 602, it is determined whether a security is set for each of the similar names (domains) searched in Step 406. As a result of the determination in Step 602, if a security is not set in Step 603, a corresponding domain is included in a search result in Step 607, and then the search result is delivered to the user in Step 609. As a result of the determination in Step 602, if a security is set as an unconditional search prohibition, i.e., search impossibility in Step 605, the searched corresponding name (domain) is delivered to the user after deleting from the search result in Step 608. As a result of the determination in Step 602, if a security setting is limited to a prescribed user group in Step 604, a current user is authenticated depending on whether the user belongs to the group in Step 606. If the user was authenticated, the corresponding domain is included in the search result in Step 607. If the user was not authenticated, the corresponding domain is deleted from the search result in Step 608 and then the similar domain search result is delivered to the user in Step 609.

The is a session technique as one example of techniques that when a user uses a web browser, after an authentication for a particular service is completed in one web browser, the particular service can be always used without re-authentication in the same browser. Using such a technique, the present invention can be configured to allow a user to freely search names accessible by him/her after he/she is authenticated once.

An Embodiment of a Case where an Internal Domain is Inputted

The present embodiment incorporates a local name server program 102 and a computer. The user computer incorporates client software 101 for operating in connection with a web browser and operating in connection with the local and central name servers through a separate interface. In addition, the central name server controls the local name server and the client software of the user computer. This is true of other embodiments.

For example, assuming that an internal domain service for members and materials in an Internet web site “www.jumbyul.com” is performed, an administrator of the web site equips the local name server 102 and applies to the central name server for an registration of a top-level domain “jumbyul” along with URL address information of the local name server (for example, “jumbyul.com”). The administrator of the web site grants an internal domain such as “service_introductionjumbyul” to information (resources) inside the web site.

The user inputs an inquiry representation “service_introductionjumbyul” in an address input window (or private software) of the web browser in order to search out a web page “service_introductionjumbyul” in his/her computer 101 (Step 201). The user computer extracts a top-level (extension) “jumbyul” from the inputted representation “service_introductionjumbyul” (Step 202). In addition, it is determined from a scheme included in the inquiry representation whether a user request is a page access request, a search request, or other application service request (Step 202). It is determined whether the extracted top-level domain (“jumbyul” in the present embodiment) is the well-known formal top-level domain (e.g., “com”, “net”, “kr”, “jp”, “org”, “shop”, “biz”, “to”, etc.). Since “jumbyul” is not the formal top-level domain, the user computer 101 delivers an inquiry to the central name server (Step 205).

The central name server 103 confirms whether “jumbyul” is a domain registered in the central name seltzer (Step 302) and then notifies a URL (“jumbybul.com”) of the local name server corresponding to “jumbyul” of the user computer (Step 303). The user computer 101 delivers the inquiry representation “service_introduction.jumbyul” and information on the scheme (classification of page access, page search, other application service, etc) to the local name server with “jumbyul.com” as an address value of the local name server corresponding to the received “jumbyul”.

The local name server (“jumbyul.com”) requested for process delivers a corresponding page to a browser of the user according to a characteristic of a required service (Step 407). If there is no corresponding page, a search page having a list of relevant or similar names is delivered to the browser of the user (Step 408) or the other application service is executed (Step 410).

In the present invention, the information stored in the table of the local name server and provided for the user computer is the information such as URL or IP.

An Embodiment of a Case where an Existing Alphabet Domain is Inputted

A user inputs a normal domain name such as www.aranes.com in his/her own computer 101.

The user computer extracts the top-level domain “com” from the inputted representation “www.aranes.com”. Since this top-level domain “com” is the well-known formal top-level (e.g., “com”, “net”, “kr”, “jp”, “org”, “shop”, “biz”, “to”, etc.), “www.aranes.com” is delivered to a general address processing module of the user computer for process.

An Embodiment of a Case where an Extension which is not Recognized is Inputted

When a user inputs an inquiry representation having no formal top-level domain, such as “www.abc.cc”, to his/her own computer 101, the user computer extracts the top-level domain “cc” from the above representation.

Subsequently, the user computer determines by using a scheme whether a user request is a page access request, a search request, other application service request, or the like. Since the top-level domain (“cc”) is not the well-known domain (e.g., “com”, “net”, “kr”, “jp”, “org”, “shop”, “biz”, “to”, etc.), an address determination is requested to the central name server (Step 205).

The central name server 103 determines whether the top-level domain “cc” is registered. If “cc” is not registered, the central name server 103 notifies “no information” of the user computer 101 (Step 304). Then, the user computer 101 passes “www.abc.cc” to a basic domain processing module (browser or other communication module) of the user computer in response to “no information” (Step 208).

An Embodiment of a Similar Domain Search Function of a Domain Server

The present embodiment relates to an process of a case where a user requests a search with an addition of “?” like “worldcupsemifinal.soccer?” or inputs misspelled domain representation, such as “worldcopsemifinal.soccer”. The user computer receives a URL (e.g., such as “jdns.sports.com) of the local name server 102 servicing internal domains of the top-level domain “soccer” for this inquiry representation from the central name server and then delivers the inputted domain representation to an address of the local name server.

In the case where “?” is suffixed, the local name server (“jdns.sports.com” in this case) determines that a user request is a search request, and searches similar domains sharing with the representation “worldcupsemifinal” all or part of character string or in terms of meaning. If ‘worldcopsemifinal.soccer” is a case not searched by a one to one way, similarity search is likely performed and then a search result is delivered to the user computer 101.

An Embodiment of Utilization of Service Security Options in a Procedure for Registering Names

When a user registers a name “worldcupsemifinalmyth.KT” in a local name server 102 of KT company, security information such as “open”, “secret”, “allowed to only group” is set so that only he/she and his/her friends can access services (page access, search, other application functions) provided by the local name server of KT company.

The local name server delivers a URL, includes the URL in a search result, or refers to the URL to see security information preset before an application service is provided, according to a service scheme requested for the name “worldcupsemifinalmyth.KT”. If the set security information is “open”, a corresponding URL is unconditionally delivered to the user, or is unconditionally included in a search result and then delivered to the user.

If the set security information is “secret”, a corresponding name domain is unconditionally excluded from the search (Step 608).

If the set security information is “allowed to only group”, it is determined whether a user to request a service is a user belonging to a group and, according to a result of the determination, it is determined whether or not the service is offered.

According to a preferred embodiment, the “secret” security option corresponds to only a case where a similarity domain search result is excluded from a result provided for the user in the similarity domain search. The reason for the option that a URL service or other application services cannot be unconditionally used is that this option is not realistic due to a conflict with a purpose of domain registration.

An Embodiment of Indication of the Scheme

When a user wishes to take various services with extended internal domains in his/her own computer 101, he/she should specify a format to indicate service contents. For example, the user can set the format in such a manner that a case where he/she inputs “patentregistration.kipo” means a service (corresponding to http://) to access a concerned page, a case where he/she inputs “patentregistrationsection.kipo?” means a similarity domain search, a case where he/she inputs “>email patent registration section.kipo” means writing of mail to an electronic mail address linked with internal domains, and a case where he/she inputs “>tel patentregistrationsection.kipo” means voice communication through a linked telephone. Notice the prefix symbol “>” is only exemplary and its function to implement sub-schema for particular top-level-domain can be embodied in various syntaxes.

When the user selects service contents according to a defined grammar and inputs an internal domain, the user computer 101 extracts a top-level domain of the internal domain. The user computer 101 delivers the top-level domain to a corresponding local name server 102 for a request of service. The local name server executes a corresponding service by executing a relevant program according to characteristics of the internal domain and the service.

There may exist various methods for expressing and selecting a plurality of access services. For example, if a user wants a FTP (file transfer protocol) using the extended internal domain which is an object of the present invention, a format such as “>ftp internalname.top-level name” may be taken. If he/she wants an e-mail, a format such as “>email name.top-level” may be taken.

In addition, by indicating the extended internal domain which is an object of the present invention and causing a domain service program of the user computer to process the extended internal domain in a standard tag language such as HTML or XGML, a system such as an existing domain system can be utilized. For example, the user can create a web document by inputting “<href-jbn://materialname.top-levelname” in a HTML document. When other users see the document through their web browsers and click a portion corresponding to “<href=jbn://materialname.top-levelname”, a name service program detects “jbn://” of link information and processes it first. Similarly, when the user inputs “jbn://>ftp materialname.top-levelname”, it is possible to provide a transfer service of a file stored in “materialname.top-levelname”. In this case, “jbn://” is a top-level scheme for distinguishing the name service of the present invention from other domain services, and “>email” and so on can be referred to as a detailed scheme of “jbn://”.

In addition, the embodiments of the present invention include a computer-readable medium including program instructions for executing operations implemented by various kinds of computers.

### INDUSTRIAL APPLICABILITY

Although there are domain services including formal top-level domains (“com”, “net”, “kr”, “jp”, etc.) defined in an international standard frame, layered Hangul domains such as “suwonuniversity.university.korea”, or domains without extension, which are known as a keyword scheme, such as “suwonuniversity”, use of all these domains is to grant a name to sites or main services. On the other hand, there exists no way that all user can easily grant names to an Internet space and delete/manage these names, or can register top-level domains with site names as if site names are registered in “com”. Although studies of URL have progressed on an international basis in order to facilitate an access to all resources, all studies have not been in common use since they hold fast to forms of existing domain names and existing service schemes, have given the first consideration to English letters, and are too complicated to be used by the general public.

The present invention provides a technique that top-level domains can be freely registered/deleted and “extended internal domains”, which are capable of granting names to a great number of information units inside sites other than site units, can be individually managed in each of site units. Accordingly, it become possible to put “extended internal domains” in common use, which results in a social change as below.

Since a concept of domain utilization is extended from a region of site administrators into a region of utilization by Internet users, the users can utilize a huge name space, compared to a current name space. While one “.com” having millions of names is now in a saturated state, the extended internal domain system has no problem of saturation because of astronomical name space.

By managing/operating a separate name server in order to provide name services for internal resources and members in each site, a security can be improved, satisfying commercial requirements, without a need of registration of names in an external domain server.

Since a user can directly access required internal information without entering internal information of a web site after accessing the web site, a significant change to site establishment and information arrangement can be induced. This induces an essential change to Internet utilization itself, which results in increase of productivity in information search.

As the Internet is reorganized as user-centered, information-centered Internet, electronic commerce is activated and a qualitative change from site-centered Internet to user and information-centered Internet can be induced.

Although the present invention can be considered as an extension and embodiment of several applications starting from an existing domain concept, on the other hand, it accomplishes effectively an object of URL to access all resources, overcoming a limitation of a URL technique to seek an expansion of function in the existing domain system.

Although the preferred embodiments of the present invention have been described for illustrative purposes, it will be apparent to those skilled in the art that various modifications, additions and substitutions can be made thereto without departing from the scope and spirit of the invention defined by the appended claims.

1. An extended internal domain service system comprising:
a client module installed at a user computer;
a local name server module installed at a local name server connected to the user computer via a network;
a central name server module installed at a central name server connected to the user computer via a network; and
an extension table stored in the central name server for maintaining an extension and an address of the local name server corresponding to the extension,
wherein the client module extracts an extension from a user inquire representation inputted from a user, determines whether the extracted extension is a formal top-level domain, delivers the user inquiry representation to an address processing module of the user computer if the extracted extension is the formal top-level domain, and delivers the user inquiry representation to the central name server if the extracted extension is not the formal top-level domain,
the central name server module searches the address of the local name server corresponding to the extension extracted from the user inquiry representation with reference to the extension table, and delivers the searched address to the user computer, and
the local name server module provides a service corresponding to the user inquiry representation.

2. The system as claimed in claim 1, further comprising a local extension table stored in the user computer for maintaining the address of the local name server corresponding to a first extension and a second extension,
wherein the client module searches the address of the local name server corresponding to the extension extracted from the user inquiry representation with reference to the local extension table if the extracted extension is not the formal top-level domain, and delivers the user inquiry representation to the central name server if the address of the local name server is not searched with reference to the local extension table.

3. The system as claimed in claim 1, further comprising an internal domain table stored in the local name server for maintaining internal domains and addresses of resources corresponding to the internal domains,
wherein the local name server module analyzes received user inquiry representation and determines whether a service request from a user is a page access request, a similarity domain search request, or other application service request, and
the internal domains maintained in the internal domain table are compared with the user inquiry representation if the service request from the user is the page access request, and an address of a corresponding resource is delivered to the user computer.

4. The system as claimed in claim 3, wherein the local name server module searches a domain similar to the internal domain extracted from the user inquiry representation among the internal domains maintained in the internal domain table and delivers the searched domain to the user computer if the service request from the user is the similarity domain search request, and
the local name server module performs an application service defined for a requested internal domain and delivers a result of the performance to the user computer if the service request from the user is other application service request.

5. The system as claimed in claim 3, wherein the internal domain table maintains authorities of users in connection with the internal domains stored in the internal domain table, and
the local name server module authenticates a user who requested the service with reference to the internal domain table and provides a service corresponding to the user inquiry representation for the user according to a result of the authentication.
